(19) United States
(12) Patent Application Publication
(10) Pub. No.: US 2026/0014918 A1
(43) Pub. Date: Jan. 15, 2026

(54) DRIVER ASSIST STRAP

(71) Applicant: Sam Samples, Cashion, OK (US)

(72) Inventor: Sam Samples, Cashion, OK (US)

(21) Appl. No.: 19/254,336

(22) Filed: Jun. 30, 2025

Related U.S. Application Data
(60) Provisional application No. 63/669,021, filed on Jul. 9, 2024.

(51) Int. Cl. B60N 3/02

(52) U.S. Cl. CPC B60N 3/026

(57) ABSTRACT

Strap apparatuses and methods of use are described herein, including a strap apparatus, comprising a strap having first and second grips and a fitting. The strap has a first end, a second end opposite the first end, and a fitting attachment member disposed at the second end. The first grip is disposed at the first end. The second grip is disposed between the first strap end and the second end. The fitting comprises a strap attachment portion and a vehicle attachment portion. The strap attachment portion comprises a complementary fitting attachment member secured to the fitting attachment member. The vehicle attachment portion comprises a vehicle attachment member configured to be releasably secured to a complementary vehicle attachment member of a cargo securement system within a cargo vehicle. The strap attachment portion and the vehicle attachment portion are connected by an articulating joint.

### CROSS-REFERENCE TO RELATED APPLICATION

This application claims priority to U.S. Provisional Patent Application No. 63/669,021, filed Jul. 9, 2024, titled “Improved Driver Assist Strap”, the content of which is incorporated herein by reference in its entirety.

### BACKGROUND

Driver assist straps—which are commonly used by drivers of cargo vehicles to aid in entering and exiting the cabs of their cargo vehicles—are essential for ensuring driver safety and convenience. However, several problems with currently existing driver assist straps have been identified. For example, currently existing driver assist straps include only a single grip, which limits the ability of currently existing driver assist straps to aid drivers. The single grip included in currently existing driver assist straps is also too large, which makes it more difficult to store and use for drivers with smaller hands and/or heavier bodies. The single grip also lacks any anti-slip features, which causes issues related to slippage when drivers attempt to use currently existing driver assist straps. The weight barrier (i.e., the maximum weight the driver assist strap can support) of currently existing driver assist straps is also insufficient, which poses a safety risk during use. Finally, the fittings by which currently existing driver assist straps are secured to cargo vehicles causes kinking in the driver assist straps, thereby compromising the overall effectiveness and longevity of the driver assist straps.

### SUMMARY

Strap apparatuses and methods of use are disclosed herein. The aforementioned problems of currently existing driver assist straps are addressed through a strap apparatus having more than one grip that (1) are lower-profile than grips of currently existing driver assist straps, (2) are constructed using non-slip materials, and (3) have a greater weight barrier than currently existing driver assist straps. Furthermore, the strap apparatus described herein includes a fitting with an articulating joint, which allows the strap apparatus to orient itself toward a pulling force exerted by the driver, thereby eliminating any kinking of the strap apparatus and allowing the strap apparatus to remain flush with the fitting.

In one exemplary implementation, the present disclosure includes a strap apparatus, comprising: a strap having a first strap end, a second strap end opposite the first strap end, and a fitting attachment member disposed at the second strap end; a terminal grip disposed at the first strap end; a proximal grip disposed between the first strap end and the second strap end; and a fitting comprising a strap attachment portion and a vehicle attachment portion, the strap attachment portion comprising a complementary fitting attachment member secured to the fitting attachment member, the vehicle attachment portion comprising a vehicle attachment member configured to be releasably secured to a complementary vehicle attachment member of a cargo securement system within a cargo vehicle, the strap attachment portion and the vehicle attachment portion connected by an articulating joint.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a perspective view of an exemplary implementation of a strap apparatus constructed in accordance with the prior art;

FIG. 2 is a perspective view of a cargo securement system within a cargo vehicle constructed in accordance with the prior art;

FIG. 3 is a perspective view of an exemplary implementation of an improved strap apparatus constructed in accordance with the present disclosure;

FIG. 4 is a partial perspective view of the improved strap apparatus shown in FIG. 3;

FIG. 5A is a front view of an exemplary implementation of a fitting shown in FIG. 4;

FIG. 5B is a partially exploded front view of the fitting shown in FIG. 5A; and

FIG. 6 is a perspective view of another exemplary implementation of an improved strap apparatus constructed in accordance with the present disclosure, the improved strap apparatus comprising three grips wherein one of the grips is disposed adjacent to a strap attachment portion of a fitting.

### DETAILED DESCRIPTION

The following detailed description refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Finally, as used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

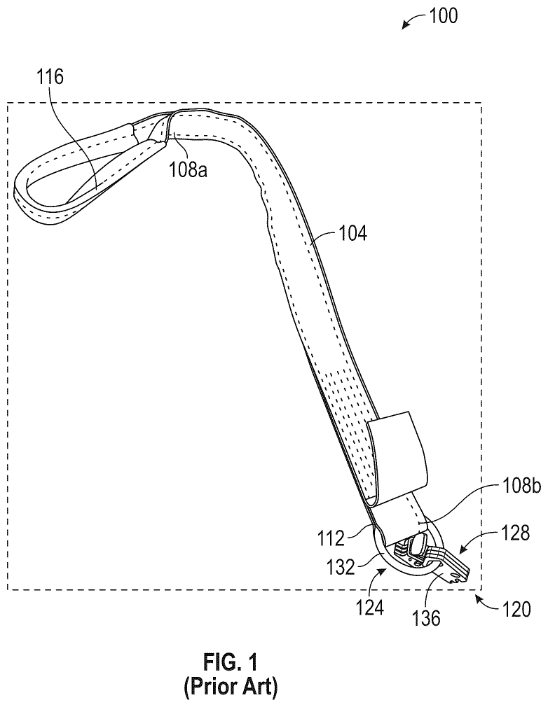

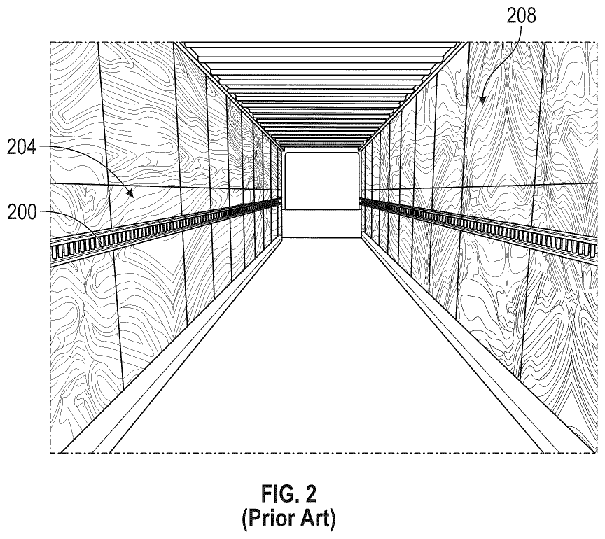

Referring now to the drawings, and in particular to FIG. 1, shown therein is an exemplary implementation of a prior art strap apparatus 100. As shown in FIG. 1, the prior art strap apparatus 100 generally comprises: a strap 104 having a first strap end 108a, a second strap end 108b opposite the first strap end 108a, and a fitting attachment member 112 disposed at the second strap end 108b; a single grip 116 disposed at the first strap end 108a; and a fitting 120 disposed proximate to the second strap end 108b. The fitting 120 generally comprises a strap attachment portion 124 and a vehicle attachment portion 128. The strap attachment portion 124 comprises a complementary fitting attachment member 132 secured to the fitting attachment member 112, while the vehicle attachment portion 128 comprises a vehicle attachment member 136 configured to be releasably secured to a complementary vehicle attachment member 200 (shown in FIG. 2) of a cargo securement system 204 (shown in FIG. 2) within a cargo vehicle 208 (shown in FIG. 2).

In some implementations, the complementary vehicle attachment member 200 of the cargo securement system 204 within the cargo vehicle 208 is an anchor point. In such implementations, the cargo securement system 204 may be a logistic track, such as an A-track, an E-track, an F-track, or an L-track, for example.

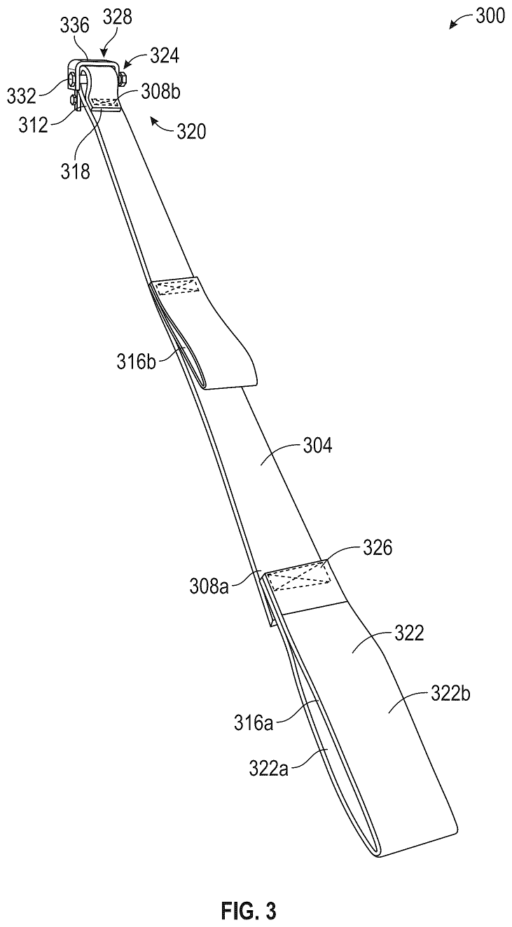

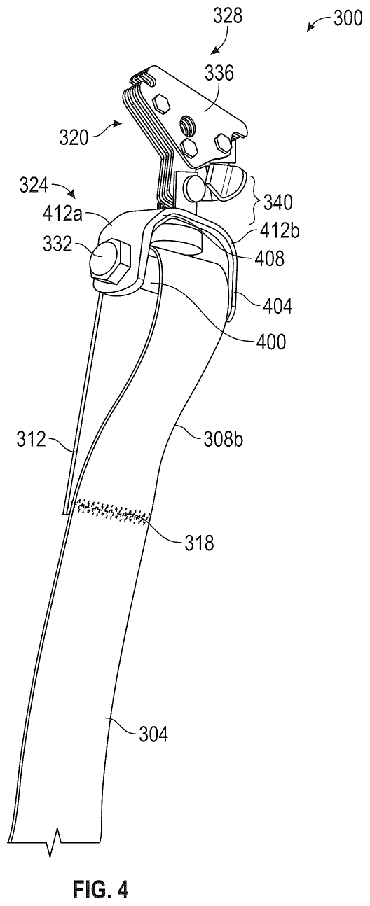

Referring now to the present invention, and in particular to FIG. 3, shown therein is an exemplary implementation of an improved strap apparatus 300 (hereinafter, the “strap apparatus 300”) constructed in accordance with the present disclosure. As shown in FIG. 3, the strap apparatus 300 generally comprises: a strap 304 having a first strap end 308a, a second strap end 308b opposite the first strap end 308a, and a fitting attachment member 312 disposed at the second strap end 308b; a terminal grip 316a disposed at the first strap end 308a; a proximal grip 316b disposed between the first strap end 308a and the second strap end 308b (the terminal grip 316a and the proximal grip 316b, collectively, the “grips 316”); and a fitting 320 disposed proximate to the second strap end 308b. The fitting 320 generally comprises a strap attachment portion 324 and a vehicle attachment portion 328. The strap attachment portion 324 comprises a complementary fitting attachment member 332 secured to the fitting attachment member 312, while the vehicle attachment portion 328 comprises a vehicle attachment member 336 configured to be releasably secured to a complementary vehicle attachment member 200 of a cargo securement system 204 within a cargo vehicle 208, such as is shown in FIG. 2. The strap attachment portion 324 and the vehicle attachment portion 328 of the fitting 320 are connected by an articulating joint 340 (shown in FIG. 4).

The strap 304 and the grips 316 of the strap apparatus 300 may be formed of a long, narrow, flexible, inelastic material. The strap 304 and the grips 316 may be formed of the same or different materials. The terminal grip 316a and proximal grip 316b may be formed of the same or different materials from one another. In some implementations, the strap 304 and/or at least one of the grips 316 may be formed of a natural material, a synthetic polymer such as polypropylene, nylon, polyester, and Kevlar, or another synthetic material such as carbon fiber. In some implementations, the strap 304 and/or at least one of the grips 316 may be formed of fabric. In such implementations, the strap 304 and/or at least one of the grips 316 may be formed as a narrow strip of webbing.

As shown in FIG. 3, the grips 316 may be constructed from an elongate material 322 such as a strip of webbed fabric. The elongate material 322 may have a first face 322a and a second face 322b opposite and reverse to the first face 322a. In some implementations, the elongate material 322 may be folded at a point substantially median of the length of the elongate material 322 such that opposing ends of the length of the elongate material 322 are adjacent to one another. The elongate material 322 may be affixed to itself about an area 326 adjacent to the opposing ends of the elongate material 322. The elongate material 322 may be affixed to itself such that the first face 322a abuts and is affixed to the first face 322a at opposing ends. The method of affixing the first face 322a at one end of the elongate material to the first face 322a at an opposing end may be any suitable stitching method such as a box X stitching method. The looped structure formed by the resulting elongate material 322 according to this method may form a grip 316.

The grips 316 may be affixed to the strap 304 at the area 326. In some implementations, affixing the grips 316 to the strap 304 and affixing the first face 322a at one end of the elongate material 322 to the first face 322a at an opposing end of the elongate material 322 may occur simultaneously or in any order. The grips 316 may be affixed to the strap 304 by any suitable method. In some implementations, the grips 316 may be affixed by a stitching method such as a box X stitching method. The grips 316 may be affixed such that the grips 316 may lay flush with the strap 304 when the strap 304 is laid flat. The grips 316 may be affixed on the same face of the strap 304 as one another.

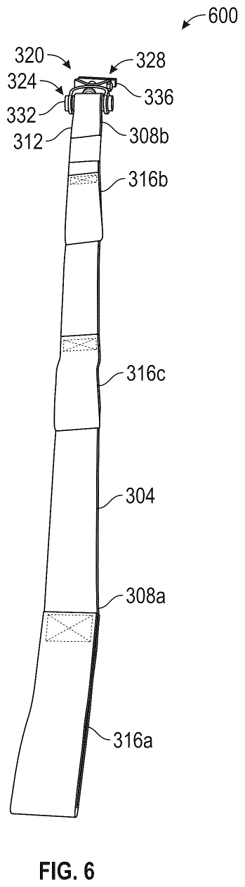

While the strap apparatus 300 is described herein as having the terminal grip 316a and the proximal grip 316b, it should be understood that the strap apparatus 300 may have a number of the grips 316 that is greater or less than two. Another exemplary implementation of a strap apparatus 600 (shown in FIG. 6) may have three of the grips 316, for example, with a medial grip 316c positioned on the strap 304 between the terminal grip 316a and the proximal grip 316b. The medial grip 316c may be formed of a material and by a method substantially similar to the terminal grip 316a and proximal grip 316b.

The strap 304 may comprise a fitting attachment member 312 at the second strap end 308b. In some implementations, as further shown in FIG. 3, the fitting attachment member 312 is a loop. In such implementations, the strap 304 at the second strap end 308b may have a U-shape that forms the loop of the fitting attachment member 312. To construct such a loop, a terminal end 318 of the strap 304 be affixed to the strap 304 at a length sufficient from the terminal end 318 such that a loop is formed as a fitting attachment member 312 for a complementary fitting attachment member 332. The terminal end 318 may be affixed by any method known to one of skill in the art to ensure sufficient stress-bearing integrity of the fitting attachment member 312. The terminal end 318 may be affixed to the strap 304 such that a face of the terminal end 318 abuts the same face of the strap 304. The terminal end 318 may be affixed to the strap 304 on the same face as the grips 316 or an opposite face. In some implementations, a method of affixing the terminal end 318 to the strap 304 may be a stitching method. In some implementations, a stitching method may comprise a double-stitching method, bar-tacking method, or box X stitching method.

Any of the above-described stitching methods is not intended to be limiting as to the method of stitching to be used and may include any variety of stitching methods known to one of skill in the art. Further, thread used to form the stitches may comprise a material the same or different to any other material used to form strap apparatus 300. In some implementations, the thread forming the stiches may comprise a sufficiently robust material which may be a natural material, a synthetic polymer such as polypropylene, nylon, polyester, and Kevlar, or another synthetic material.

In one exemplary method of construction, a strap apparatus may be constructed by first providing a strap 304 having a first strap end 308a, a second strap end 308b opposite the first strap end, and a terminal end 318 proximate to the second strap end 308b. The terminal end 318 may be affixed to a portion of the strap 304 to form a loop at the second strap end 308b, this loop serving as a fitting attachment member 312. This affixing step may involve various stitching methods as discussed above to ensure stress-bearing integrity. A complementary fitting attachment member 332 may be secured to the fitting attachment member 312. A first grip (e.g., terminal grip 316a) is affixed onto the strap 304, and a second grip (e.g., proximal grip 316b) is affixed onto the strap 304. As described above, these grips may be formed by folding an elongate material and affixing the elongate material to itself, then stitching the folded elongate material to the strap body

In some implementations, one or more component of the strap apparatus 300 is constructed using a non-slip material. In some implementations, one or more component of the strap apparatus 300 is constructed with a non-slip surface (i.e., a surface that at least partially impedes slippage between a user's hand and the one or more component of the strap apparatus 300). The non-slip surface may be formed from a property of the material used or may be an additional material applied or affixed to an outer surface of the strap apparatus.

In some implementations, the strap 304 has a working load limit in a range between 500 lbs. and 5,000 lbs. In at least one implementation, the strap 304 has a working load limit of 3,333 lbs. In some implementations the strap 304 has a breaking strength of 2,500 lbs. to 25,000 lbs. In at least one implementation, the strap 304 has a breaking strength of 10,000 lbs. In at least one other implementation, the strap 304 has a breaking strength of 16,665 lbs.

Referring now to FIG. 4, shown therein is another exemplary implementation of the strap apparatus 300 shown in FIG. 3. As discussed above, the strap attachment portion 324 and the vehicle attachment portion 328 of the fitting 320 are connected by an articulating joint 340. As further shown in FIG. 4, in some implementations, the complementary fitting attachment member 332 has a shaft 400. In such implementations, the strap attachment portion 324 of the fitting 320 may further comprise a C-shaped bracket 404. The C-shaped bracket 404 may be a rounded or polygonal C-shaped bracket 404. The C-shaped bracket 404 may have a central portion 408, a first side portion 412a extending from the central portion 408, and a second side portion 412b extending from the central portion 408 opposite the first side portion 412a. In such implementations, the shaft 400 may be further configured to be releasably secured between the first side portion 412a and the second side portion 412b of the C-shaped bracket 404 such that the loop (i.e., the fitting attachment member 312) is releasably secured to the complementary fitting attachment member 332 between the first side portion 412a and the second side portion 412b of the C-shaped bracket 404.

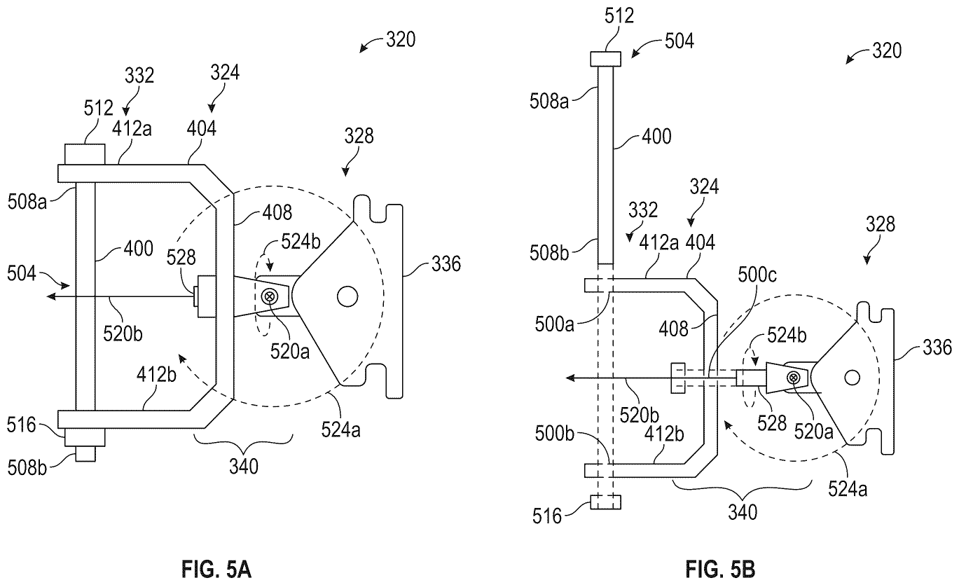

Referring now to FIGS. 5A and 5B, shown therein is another exemplary implementation of the fitting 320 shown in FIGS. 3 and 4. As shown in FIG. 5B, the first side portion 412a of the C-shaped bracket 404 may define a first engagement hole 500a, and the second side portion 412b may define a second engagement hole 500b. The first engagement hole 500a and the second engagement hole 500b are shown in phantom in FIG. 5B. As shown in FIG. 5A, the first engagement hole 500a and the second engagement hole 500b of the fitting 320 may be configured to releasably engage the shaft 400 of the complementary fitting attachment member 332.

In some implementations, the complementary fitting attachment member 332 comprises a bolt 504 having the shaft 400. In such implementations, the shaft 400 may have a first shaft end 508a and a second shaft end 508b opposite the first shaft end 508a, and the bolt 504 may have a head 512 disposed at the first shaft end 508a of the shaft 400. In such implementations, the shaft 400 may be configured to be threaded through the first engagement hole 500a and the second engagement hole 500b such that the head 512 of the bolt 504 abuts the first engagement hole 504a and the second shaft end 508b extends from the second engagement hole 504b. In such implementations, the complementary fitting attachment member 332 may further comprise a nut 516. The nut 516 may be configured to releasably engage the shaft 400 at the second shaft end 508b such that the nut 516 abuts the second engagement hole 500b and the bolt 504 is secured in place.

In some implementations, the articulating joint 340 has a first axis 520a and a second axis 520b different from the first axis 520a. In such implementations, the articulating joint 340 may be configurable to be movable (i.e., in a range indicated by a first arrow 524a in FIGS. 5A and 5B) around the first axis 520a. In some implementations, the articulating joint 340 may further include a stud 528. In such implementations, the central portion 408 of the C-shaped bracket 404 may have a third engagement hole 500c, and the stud 528 may be positioned within the third engagement hole 500c. In such implementations, the stud 528—and, therefore, the vehicle attachment portion 328 of the fitting 320—may be configurable to be rotatable (i.e., in a range indicated by a second arrow 524b in FIGS. 5A and 5B) around the second axis 520b. Thus, in some implementations, the articulating joint 340 may be configurable to be movable around the first axis 520a and the second axis 520b such that the strap attachment portion 324 and the vehicle attachment portion 328 are movable relative to each other. In some implementations, the first axis 520a is offset 90 degrees from the second axis 520b. Accordingly, the articulating joint 340 may allow the strap attachment portion 324 to orient itself toward a pulling force exerted by a driver, thereby eliminating any kinking of the strap apparatus 300 and allowing the strap 304 to remain flush with the fitting 320.

The fitting 320 may comprise materials sufficiently durable and robust for the purposes described herein. For example, the fitting 320 may comprise metals such as iron, aluminum, brass, titanium, or a steel such as stainless steel, carbon steel, or another alloyed steel. The fitting 320 may also or alternatively be comprised of robust plastics such as polycarbonate, nylon, polyethylene, and polypropylene. The fitting 320 and components thereof may comprise any number of materials alone or in combination, and any individual component of the fitting 320 may comprise a material different from any other component. These materials are exemplary and are not intended to be limiting, and it is intended that any natural or synthetic material suitable for the purposes described herein may be utilized.

Referring now to FIG. 6, shown therein is another exemplary implementation of an improved strap apparatus 600 (hereinafter, the “strap apparatus 600”) constructed in accordance with the present disclosure. The strap apparatus 600 shown in FIG. 6 may be identical in construction and function to the strap apparatus 300 shown in FIG. 3, except that the strap apparatus 600 shown in FIG. 6 further comprises a medial grip 316c disposed in between the terminal grip 316a and the proximal grip 316b. That is, similar to the strap apparatus 300 shown in FIG. 3, the strap apparatus 600 generally comprises: the strap 304 having the first strap end 308a, the second strap end 308b opposite the first strap end 308a, and the fitting attachment member 312 disposed at the second strap end 308b; the terminal grip 316a disposed at the first strap end 308a, the proximal grip 316b disposed proximate to the second strap end 308b, the medial grip disposed between the medial grip 316c disposed between the terminal grip 316a and the proximal grip 316b, and the fitting 320 disposed proximate to the second strap end 308b. The fitting 320 generally comprises the strap attachment portion 324 and the vehicle attachment portion 328. The strap attachment portion 324 comprises the complementary fitting attachment member 332 secured to the fitting attachment member 312, while the vehicle attachment portion 328 comprises the vehicle attachment member 336 configured to be releasably secured to a complementary vehicle attachment member 200 of a cargo securement system 204 within a cargo vehicle 208, such as is shown in FIG. 2. However, unlike the strap apparatus 300 shown in FIG. 3, the strap apparatus 600 shown in FIG. 6 further comprises the medial grip 316c disposed between the terminal grip 316a and the proximal grip 316b. The strap 304 and the fitting 320 shown in FIG. 6 may be identical in construction and function to the strap 304 and the fitting 320 shown in FIG. 3.

In a method of using the strap apparatus 300 or strap apparatus 600, a user may secure the vehicle attachment member 336 of the fitting 320 to the complementary vehicle attachment member 200 of a cargo securement system 204 within a cargo vehicle 208 (as depicted in FIG. 2). Once secured, a user may grasp either the terminal grip 316a, the proximal grip 316b, the medial grip 316c (for the strap apparatus 600) or any combination of the grips 316. Subsequently, the user may apply a pulling force to the grasped grip(s) 316. This applied pulling force may provide the necessary assistance for the user to safely ascend into the cargo vehicle's cab, descend from the cab, or stabilize themselves during entering or exiting of a cargo vehicle. During the application of a pulling force, the articulating joint 340 of the fitting 320 may orient the strap attachment portion 324 toward the direction of the pulling force. This dynamic reorientation may prevent the strap 304 from kinking at its connection point to the fitting 320, ensuring the strap remains flush and provides consistent support throughout a user's ascent, descent, or stabilization.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A strap apparatus, comprising:
a strap having a first strap end, a second strap end opposite the first strap end, and a fitting attachment member disposed at the second strap end;
a terminal grip disposed at the first strap end;
a proximal grip disposed between the first strap end and the second strap end; and
a fitting comprising a strap attachment portion and a vehicle attachment portion, the strap attachment portion comprising a complementary fitting attachment member secured to the fitting attachment member, the vehicle attachment portion comprising a vehicle attachment member configured to be releasably secured to a complementary vehicle attachment member of a cargo securement system within a cargo vehicle, the strap attachment portion and the vehicle attachment portion connected by an articulating joint.

2. The strap apparatus of claim 1, wherein the fitting attachment member is a loop.

3. The strap apparatus of claim 2, wherein the strap at the second strap end has a U-shape forming the loop.

4. The strap apparatus of claim 2, wherein the complementary fitting attachment member has a shaft, the strap attachment portion further comprising a C-shaped bracket having a central portion, a first side portion extending from the central portion, and a second side portion extending from the central portion opposite the first side portion, the shaft further configured to be releasably secured between the first side portion and the second side portion such that the loop is releasably secured to the complementary fitting attachment member between the first side portion and the second side portion.

5. The strap apparatus of claim 4, wherein the first side portion defines a first engagement hole, the second side portion defining a second engagement hole, the first engagement hole and the second engagement hole configured to releasably engage the shaft.

6. The strap apparatus of claim 5, wherein the complementary fitting attachment member comprises a bolt having the shaft.

7. The strap apparatus of claim 6, wherein the shaft has a first shaft end, a second shaft end opposite the first shaft end, the bolt further having a head disposed at the first shaft end, the shaft configured to be threaded through the first engagement hole and the second engagement hole such that the head abuts the first engagement hole and the second shaft end extends from the second engagement hole.

8. The strap apparatus of claim 7, wherein the complementary fitting attachment member further comprises a nut configured to releasably engage the shaft at the second shaft end such that the nut abuts the second engagement hole.

9. The strap apparatus of claim 1, wherein the vehicle attachment member is further configured to be releasably secured to an anchor point of a logistic track within the cargo vehicle.

10. The strap apparatus of claim 1, wherein the vehicle attachment member is further configured to be releasably secured to an anchor point of one of an A-track, an E-track, an F-track, and an L-track within the cargo vehicle.

11. The strap apparatus of claim 1, wherein the articulating joint has a first axis and a second axis different from the first axis, and wherein the articulating joint is configurable to be movable around the first axis.

12. The strap apparatus of claim 11, wherein the articulating joint includes a stud, and wherein the strap attachment portion further comprising a C-shaped bracket having a central portion, a first side portion extending from the central portion, and a second side portion extending from the central portion opposite the first side portion, the central portion having a hole, and wherein the stud is positioned within the hole and rotatable within the hole.

13. The strap apparatus of claim 1, wherein the articulating joint has a first axis and a second axis different from the first axis, and wherein the articulating joint is configurable to be movable around the first axis and the second axis such that the strap attachment portion and the vehicle attachment portion are movable relative to each other.

14. The strap apparatus of claim 1, further comprising a medial grip disposed between the terminal grip and the proximal grip.

15. A method for constructing a strap apparatus, comprising:
providing a strap having a first strap end, a second strap end opposite the first strap end, and a terminal end proximate to the second strap end;
affixing the terminal end to a portion of the strap to form a loop at the second strap end, the loop being a fitting attachment member;
securing a complementary fitting attachment member to the fitting attachment member;
affixing a first grip onto the strap; and
affixing a second grip onto the strap.

16. The method of claim 15, wherein the step of affixing the terminal end to a portion of the strap includes stitching the terminal end to a portion of the strap by a double-stitching method, a bar-tacking method, box X stitching method, or any combination thereof.

17. The method of claim 15, wherein the step of affixing a first grip onto the strap and the step of affixing a second grip onto the strap comprise:
providing a strip of material having a first face, a second face reverse to the first face, a first end, and a second end opposite the first end;
affixing the first end to the second end along the first face to form a grip; and
affixing the grip to the strap along the second face.

18. The method of claim 15 further comprising the step of affixing a third grip onto the strap between the first grip and the second grip.

19. A method comprising:
providing a strap apparatus, comprising:
a strap having a first strap end, a second strap end opposite the first strap end, and a fitting attachment member disposed at the second strap end;
a terminal grip disposed at the first strap end;
a proximal grip disposed between the first strap end and the second strap end; and
a fitting comprising a strap attachment portion and a vehicle attachment portion, the strap attachment portion comprising a complementary fitting attachment member secured to the fitting attachment member, the vehicle attachment portion comprising a vehicle attachment member configured to be releasably secured to a complementary vehicle attachment member of a cargo securement system within a cargo vehicle, the strap attachment portion and the vehicle attachment portion connected by an articulating joint;
securing the vehicle attachment member to the complementary vehicle attachment member;
grasping the terminal grip, the proximal grip, or both; and
applying a pulling force to the terminal grip, the proximal grip, or both, to assist with ascending, descending, or stabilizing a user with respect to the cargo vehicle.

20. The method of claim 19, further comprising the step of orienting the strap in a direction of the pulling force via the articulating joint.
